(19) United States
(12) Patent Application Publication
(10) Pub. No.: US 2016/0073572 A1
(43) Pub. Date: Mar. 17, 2016

(54) ADJUSTABLE MULTIPLE ROW AGRICULTURAL IMPLEMENT

(71) Applicant: Bigham Brothers, Inc., Lubbock, TX (US)

(72) Inventors: Samuel L. Evans, Little Rock, AR (US); Benjamin C. Parker, North Little Rock, AR (US)

(21) Appl. No.: 14/854,033

(22) Filed: Sep. 14, 2015

Related U.S. Application Data
(60) Provisional application No. 62/049,723, filed on Sep. 12, 2014.

(51) Int. Cl. A01B 63/00; A01B 73/04; A01B 49/02

(52) U.S. Cl. CPC A01B 63/004; A01B 49/027; A01B 73/044

(57) ABSTRACT

A multiple row agricultural implement with adjustable ground-working tools which allows use with a variety of row spacing configurations. Ground-working tools, which may include chopper baskets, drag harrow spikes, drag boards, rollers, etc., are mounted on each of two or more fixed width sections of a tool bar. Embodiments of such horizontal adjustability of the ground-working tools may include sliding ground-working tools along a horizontal axis to alternate positions; removing ground-working tools, reversing the ground-working tools 180 degrees, and reattaching the ground-working tools; removing ground-working tools, swapping positions of the ground-working tools, and reattaching the ground-working tools; or removing ground-working tools and reattaching the ground-working tools in an alternate position.

### CROSS-REFERENCE TO RELATED APPLICATION

This application claims priority in and incorporates by reference U.S. Provisional Patent Application No. 62/049,723, filed Sep. 12, 2014.

### BACKGROUND OF THE INVENTION

1. Field of the Invention

The present invention relates generally to agricultural farm equipment and, in particular, to multiple row agricultural implements that act on multiple crop rows at one time, the implements to be towed behind a tractor or other suitable vehicle for working a field or other piece of land.

2. Description of the Related Art

Tillage implements are generally towed behind tractors and can be equipped with one or more ground-working tools for conditioning and leveling soil behind a tractor during a tilling operation. There are two types of tillage implements: discreet implements, which act on a single row or point of the field, and multiple row implements, which act on multiple crop rows at one time. The present invention relates to a multiple row implement. Typical crop rows have alternating beds and furrows, with transitions in between. Beds are raised sections of land with a minimum width of conditioned soil for planting crops, and furrows are lower sections of land used for water routing. During operation, the ends of ground-working tools of tillage implements that cover multiple rows must not be pulled through crop row beds. Rather, the ends must be pulled over a furrow or transition area. This is necessary so that already-tilled and yet-to-be-tilled beds are not damaged. Typical multiple row tillage implements have ground-working tools at fixed locations. Thus, use of a typical multiple row tillage implement is limited to one or two row spacing configurations because the ground-working tool ends only line up with furrows or transitions for one or two different row spacing configurations. If used with other row spacing configurations, the ground-working tool ends of a typical multiple row tillage implement would be dragged through crop row beds. The present invention solves this problem with an adjustable multiple row implement capable of use for many different row spacing configurations.

Heretofore there has not been available an agricultural implement with the advantages and features of the disclosed subject matter.

### SUMMARY OF THE INVENTION

The present invention provides adjustability of ground-working tools of an agricultural implement, allowing for use of the implement with a variety of crop row spacing configurations. In the practice of an aspect of the present invention, a multiple row tillage implement includes a tool bar mounting ground-working tools. In an exemplary embodiment, these ground-working tools include chopper baskets, harrow spikes, and drag boards. The tool bar of the tillage implement has three or more separate fixed width sections, and a metal frame and ground-working tools are connected to each section. These fixed width sections include a left wing fixed width section, a right wing fixed width section, and one or more center fixed width sections. The ground-working tools mounted on fixed width sections of this invention are moveable to alternate positions in relation to the center of the implement. Repositioning the ground-working tools to alternate positions allows for use of this implement for many different row spacing configurations. The present invention permits someone to use one multiple row agricultural implement for working crop rows with each of the most common spacing configurations (i.e., 12 Row 36″, 12 Row 38″, 12 Row 40″, and 16 Row 30″) rather than needing different implements to achieve this. The adjustability is useful and convenient for farmers who are end-users of the implements as well as retailers who no longer need to keep as many different implements in their inventory.

In an exemplary embodiment, horizontal adjustability is applied to ground-working tools of a furrow roller used for the preparation of seed beds so it can be used for various row spacing configurations. An example of such a furrow roller is described in U.S. Pat. No. 7,021,397, entitled “FOLDING FURROW ROLLER FOR THE PREPARATION OF SEED BEDS,” which patent is incorporated by reference.

In another exemplary embodiment, horizontal adjustability is applied to ground-working tools of a furrow clearing apparatus used for the preparation of seed beds so it can be used for various row spacing configurations. An example of such a furrow clearing apparatus is described in U.S. Pat. No. 7,975,775, entitled “FURROW CLEARING APPARATUS FOR THE PREPARATION OF SEED BEDS,” which patent is incorporated by reference.

In other embodiments, the horizontal adjustability of the present invention is applied to any type of multiple row agricultural implement so that it can be used for a variety of crop row spacing configurations.

### BRIEF DESCRIPTION OF THE DRAWINGS

The drawings constitute a part of this specification and include exemplary embodiments of the present invention illustrating various objects and features thereof.

FIG. 1 is an upper, back, perspective view of a multiple row tillage implement embodying an aspect of the present invention.

FIG. 2 is a top, plan view of the multiple row tillage implement.

FIG. 3 is a side, elevational view of the multiple row tillage implement.

FIG. 4 is a front, elevational view of the multiple row tillage implement with one wing section folded up to transport position.

FIG. 5 is a front, perspective, close-up view of chopper blades and connections of a chopper basket of the multiple row tillage implement.

FIG. 6 is a front, perspective, exploded view of flange bearing connections for chopper baskets of the multiple row tillage implement.

FIG. 7A is a front, elevational view of an embodiment of the multiple row tillage implement configured for horizontal adjustment by sliding ground-working tools along a horizontal shaft with ground-working tools in a first position.

FIG. 7B is a front, elevational view of an embodiment of the multiple row tillage implement configured for horizontal adjustment by sliding ground-working tools along a horizontal shaft with ground-working tools in a second position.

FIG. 8A is a front, elevational view of an embodiment of the multiple row tillage implement configured for horizontal adjustment by reversing ground-working tools 180 degrees with ground-working tools in a first position.

FIG. 8B is a front, elevational view of the wing section of an embodiment of the multiple row tillage implement configured for horizontal adjustment by reversing ground-working tools 180 degrees.

FIG. 8C is a front, elevational view of an embodiment of the multiple row tillage implement configured for horizontal adjustment by reversing ground-working tools 180 degrees with ground-working tools in a second position.

FIG. 9A is a front, elevational view of an embodiment of the multiple row tillage implement configured for horizontal adjustment by swapping positions of ground-working tools with ground-working tools in a first position.

FIG. 9B is a front, elevational view of an embodiment of the multiple row tillage implement configured for horizontal adjustment by swapping positions of ground-working tools with ground-working tools in a second position.

FIG. 10A is a front, elevational view of a wing section of the multiple row tillage implement over typical crop rows in an unwanted position.

FIG. 10B is a front, elevational view of a wing section of the multiple row tillage implement over typical crop rows in proper position.

FIG. 11A shows a top, plan view of the multiple row tillage implement over crop rows with ground-working tools in a first position.

FIG. 11B shows a front, elevational view of the multiple row tillage implement over crop rows with ground-working tools in a first position.

FIG. 12A shows a top, plan view of the multiple row tillage implement over crop rows with ground-working tools in a second position.

FIG. 12B shows a front, elevational view of the multiple row tillage implement over crop rows with ground-working tools in a second position.

FIG. 13 is an upper, back, perspective view of a metal frame component and drag board assembly of one side of the multiple row tillage implement.

FIG. 14 is an upper, back, perspective view of a wing section of the multiple row tillage implement with assembled drag harrow spikes and a drag board assembly.

FIG. 15 is an exploded, upper, front, perspective view of the metal frame and tool bar components of a wing section of the multiple row tillage implement.

FIG. 16 is an upper, perspective view of a drag harrow spikes component of the multiple row tillage implement.

FIG. 17 is an exploded, upper, perspective view of a drag harrow spikes component of the multiple row tillage implement.

FIG. 18 is an upper, back, perspective view of a wing section of the multiple row tillage implement showing drag harrow spike adjustment.

FIG. 19 is an exploded, upper, back, perspective view of a drag board assembly of the multiple row tillage implement.

FIG. 20 is an upper, back, perspective view of a wing section of the multiple row tillage implement showing drag board adjustment.

FIG. 21 is a side, elevational view of a multiple row tillage implement embodying another aspect of the present invention.

### DETAILED DESCRIPTION OF THE PREFERRED EMBODIMENTS

### I. Introduction and Environment

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. Said terminology will include the words specifically mentioned, derivatives thereof and words of similar meaning.

### II. Preferred Embodiment

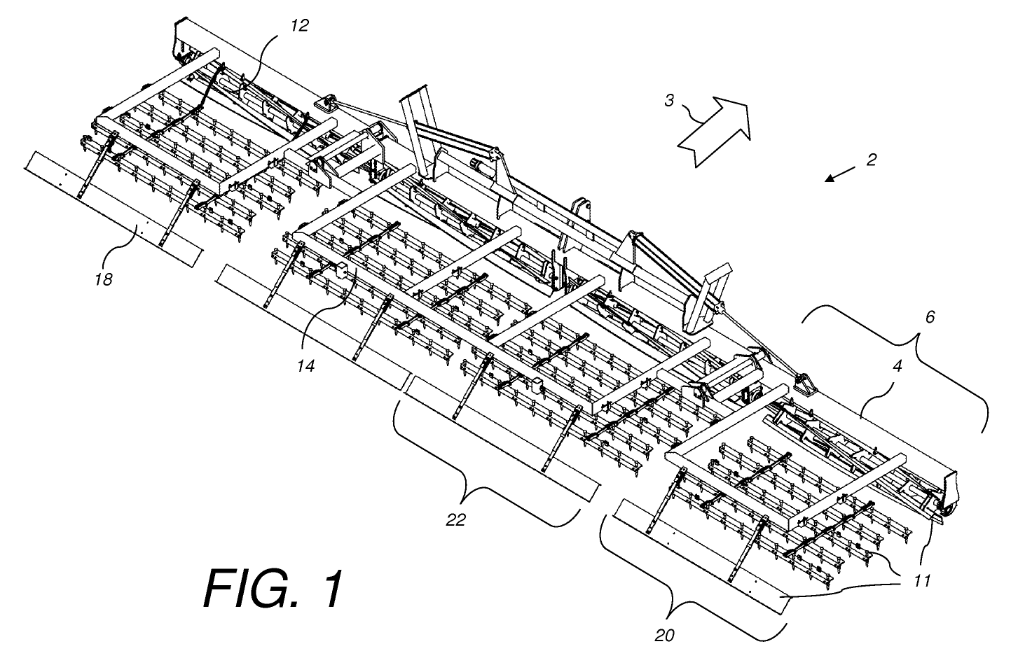

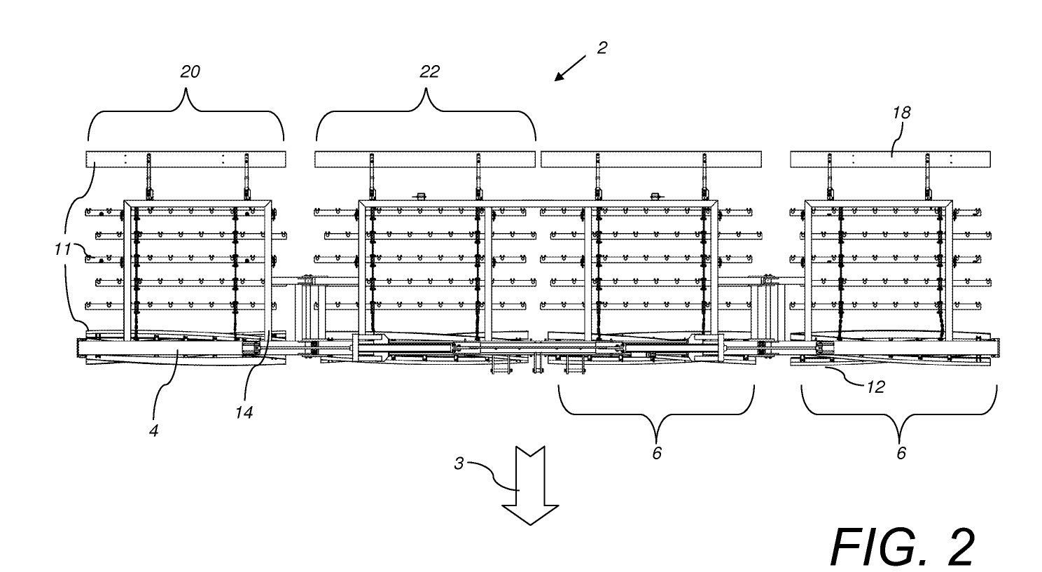

Referring to the drawings in more detail, the reference numeral 2 generally designates a multiple row agricultural implement having adjustable ground-working tools to allow use with many different crop row spacing configurations, the implement to be towed by a tractor or other suitable vehicle. In an embodiment of the present invention, as shown in FIG. 1 through FIG. 20, the adjustable multiple row agricultural implement 2 is a tillage implement with adjustable ground-working tools. This embodiment of a tillage implement 2 is generally constructed from a tool bar 4 with four fixed width sections 6. Alternatively, the ground-working tool adjustability of the present invention can be applied to agricultural implements having any other number of fixed width sections, including but not limited to two-section, three-section, five-section, and six-section folding implements. In this embodiment, each fixed width section 6 has a metal frame 14 welded to the tool bar 4 and mounts ground-working tools 11. The ground-working tools 11 on each fixed width section 6 include a chopper basket 12 connected to the tool bar 4; five bar drag harrow spikes 16 connected to the metal frame 14 and to the tool bar 4; and a drag board assembly 18 connected to the metal frame 14. With this configuration of ground-working tools 11, chopper baskets 12 size residue and break down old, hard soil; harrow spikes 16 stir and mix residue; and drag boards 18 smooth soil to ready the soil for planting.

In alternative embodiments, various other combinations of ground-working tools 11 may be mounted to the tool bar 4 and/or metal frames 14. Other combinations of ground working tools 11 may include but are not limited to: cylinders, coil tines, ripper shanks, shovels, chisels, knives, sweeps, fertilizer injectors, and/or coulter discs. Different ground-working tool configurations are typically chosen based on specific field conditions, crops, growing seasons, and related conditions. In this application, “ground-working tools” is synonymous with “earth-working tools,” “field-working tools,” and “soil-working tools.” In this embodiment, the fixed width sections 6 of tillage implement 2 consist of two wing sections 20 and two center sections 22. The tillage implement 2 has a category 3/4N three-point hitch for connecting to a vehicle. Reference numeral 3 refers to the direction of travel of the implement 2.

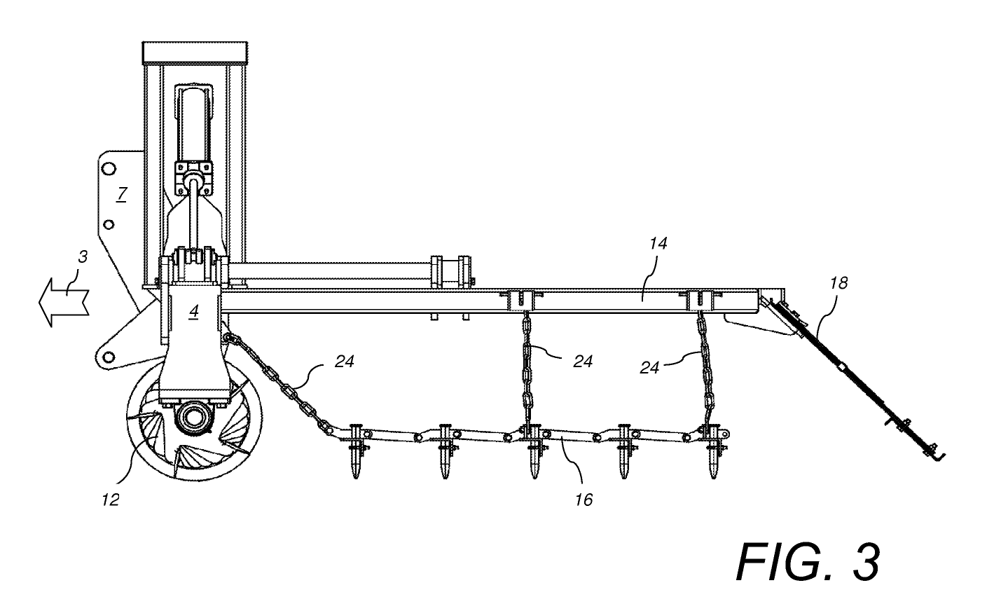

As shown by the embodiment in FIG. 3, chopper baskets 12 connect to the tool bar 4. The tool bar 4 has connections 7 for a hitch assembly capable of category III and category IV connections. The five bar drag harrow spikes 16 connect to both the metal frame 14 and the tool bar 4 via chain linkages 24. In this embodiment, the tillage implement 2 has drag board assemblies 18 bolted to the back of the metal frame 14 of each fixed width section 6.

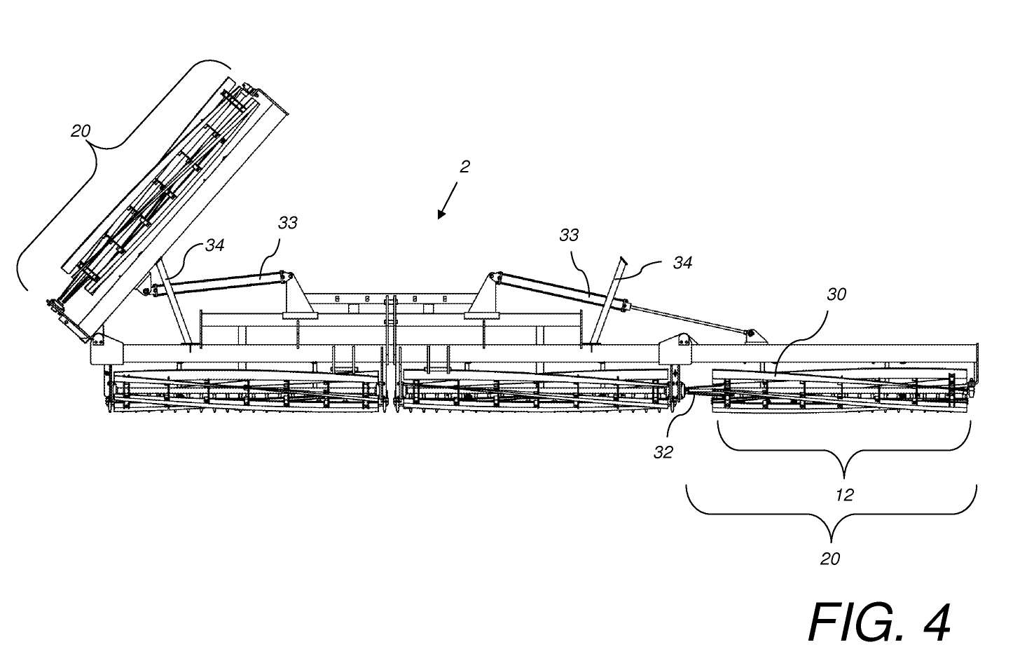

In an embodiment of the present invention shown in FIG. 4, each chopper basket 12 includes five chopper blades 30, and the chopper blades 30 are configured for rotation around a horizontal shaft 32. The wing fixed width sections 20 of the tillage implement 2 are capable of folding up to a transport position. The tillage implement 2 includes a pair of hydraulic piston-and-cylinder units 33, which aid in folding up the wing fixed width sections 20 into transport position. Transport position connectors 34 help support the weight of the wing fixed width sections 20 while in transport position.

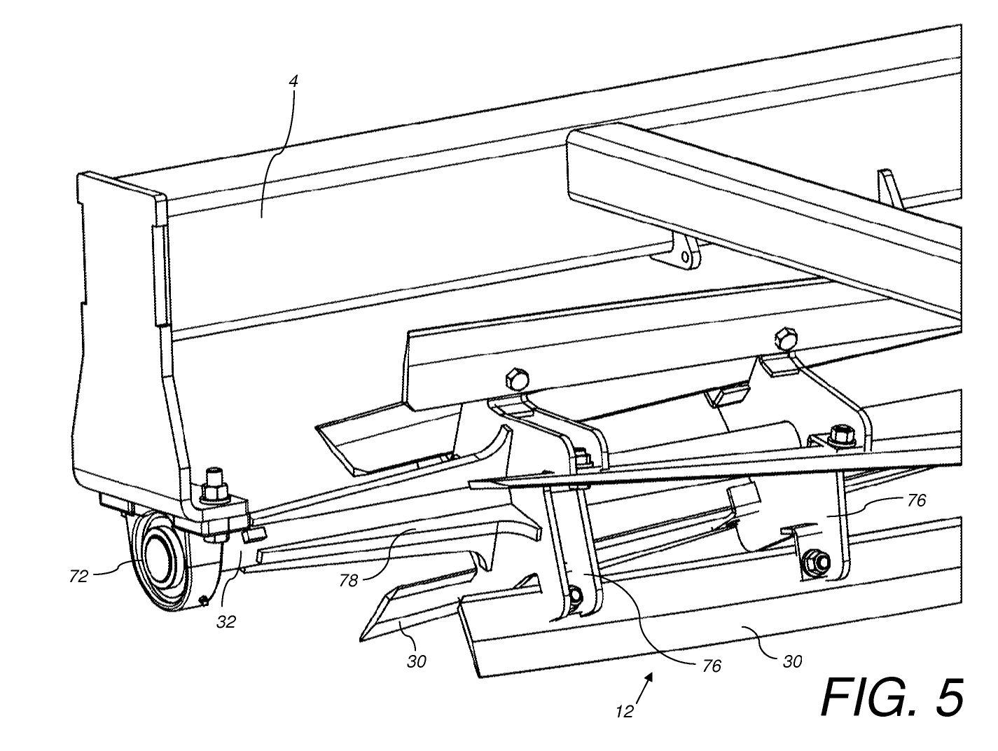

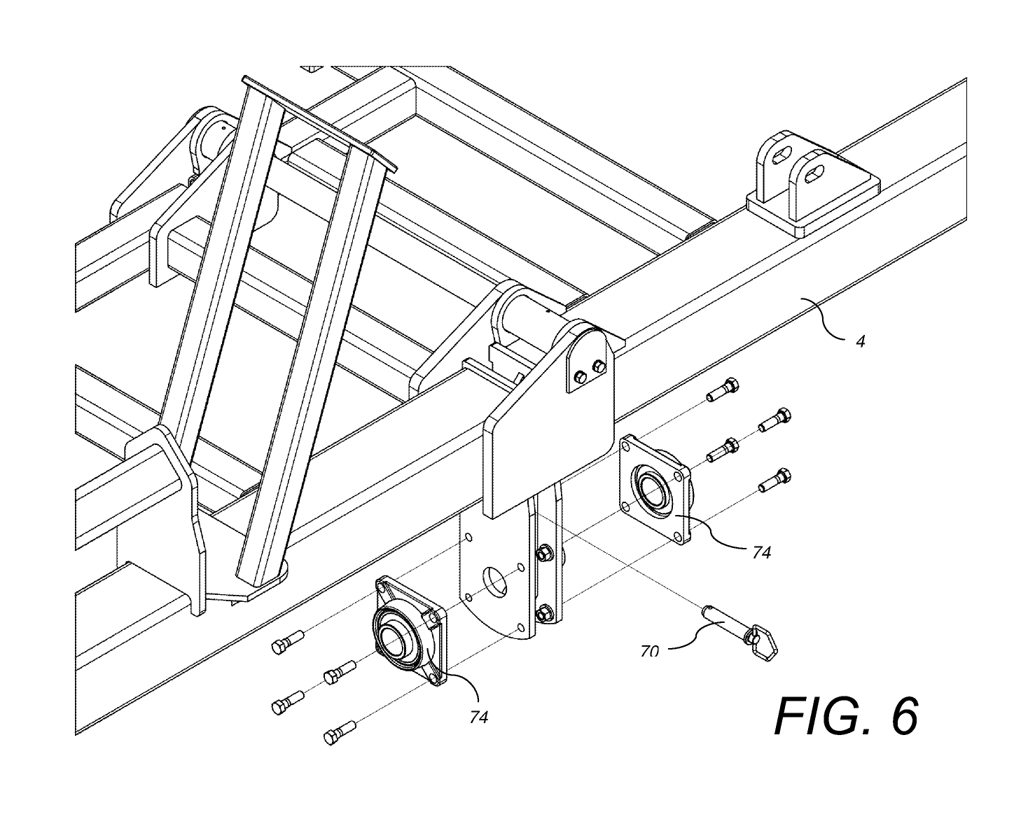

FIG. 5 is a close-up view of a chopper basket 12 of the tillage implement 2. FIG. 6 shows an exploded view of bolts and flange bearings 74 for connections to the chopper baskets 12. Each chopper basket has five beveled chopper blades 30 bolted in place to a series of spider plate assemblies 76 surrounding a horizontal shaft 32. The chopper blades 30 rotate around the horizontal shaft 32 and are held in position by a chopper gusset 78. The horizontal shafts 32 of the wing section 20 chopper baskets 12 connect directly to a two-bolt pillow block bearing 72 and a four-bolt flange bearing 74. Each horizontal shaft 32 of the center section 22 chopper baskets 12 connects directly to two four-bolt flange bearings 74. Pins 70 are used to lock the wing fixed width sections 20 in place in working and transport positions.

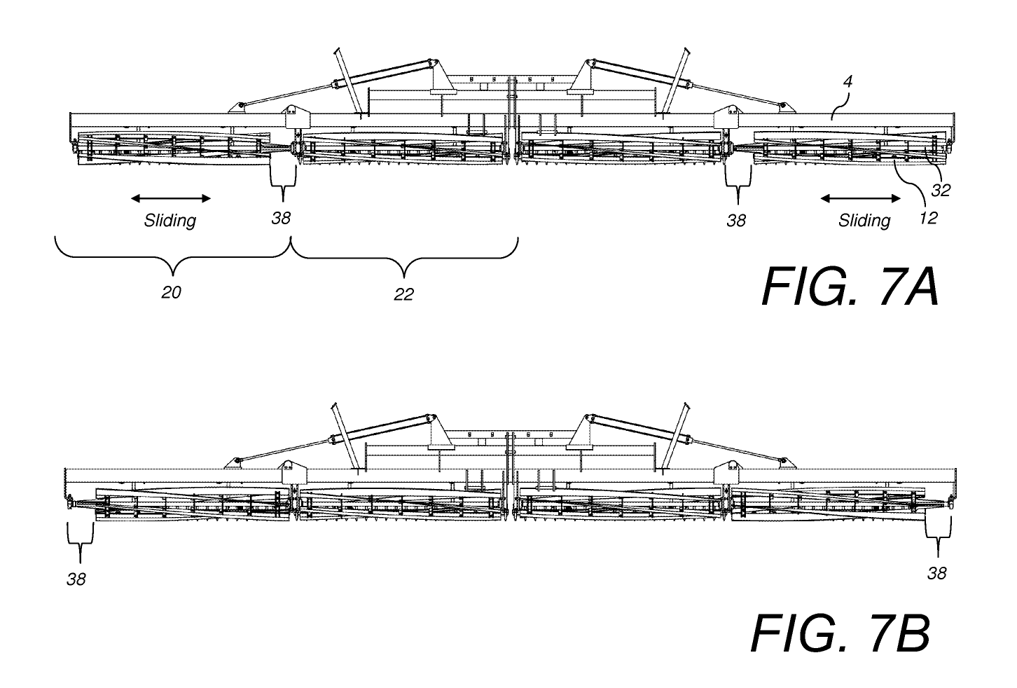

As shown in FIG. 7A and FIG. 7B, in an embodiment of the present invention, the chopper baskets 12 on the wing fixed width sections 20 of the tillage implement 2 are capable of adjustment by sliding the chopper baskets 12 along a horizontal shaft 32 and securing the chopper baskets 12 in a desired position. In this embodiment, a first, outboard position of the chopper baskets 12, as shown in FIG. 7A, puts a 12-inch displacement 38 between the wing section 20 chopper baskets 12 and the corresponding center fixed width sections 22 of the tillage implement 2. A second, inboard position of the chopper baskets 12, as shown in FIG. 7B, puts a 12-inch displacement 38 on the outside of each wing section 20 chopper basket 12.

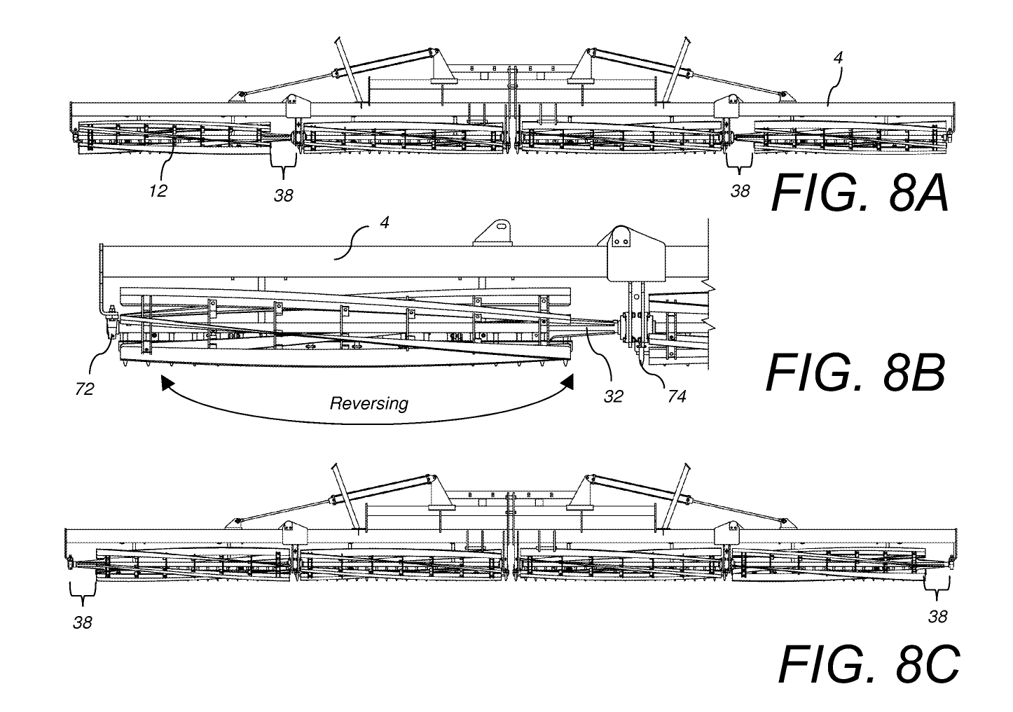

As shown in FIG. 8A, FIG. 8B, and FIG. 8C, in an embodiment of the present invention, the chopper baskets 12 on the wing fixed width sections 20 of the tillage implement 2 can be adjusted by removing four bolts from each wing flange bearing 74 and two bolts from each pillow block bearing 72; removing the wing chopper baskets 12 from the tool bar 4; reversing the wing chopper baskets 12 180 degrees; reattaching the wing chopper baskets 12 to the tool bar 4 in a desired position; and reattaching the bolts to the flange bearings 74 and the pillow block bearings 72. In this embodiment, a first, outboard position of the chopper baskets 12, as shown in FIG. 8A, puts a 12-inch displacement 38 between the wing section 20 chopper baskets 12 and the corresponding center fixed width sections 22 of the tillage implement 2. A second, inboard position of the chopper baskets 12, as shown in FIG. 8C, puts a 12-inch displacement 38 on the outside of each wing section 20 chopper basket 12. FIG. 8B shows a closer view of a wing section 20 chopper basket 12 capable of horizontal adjustment by reversal.

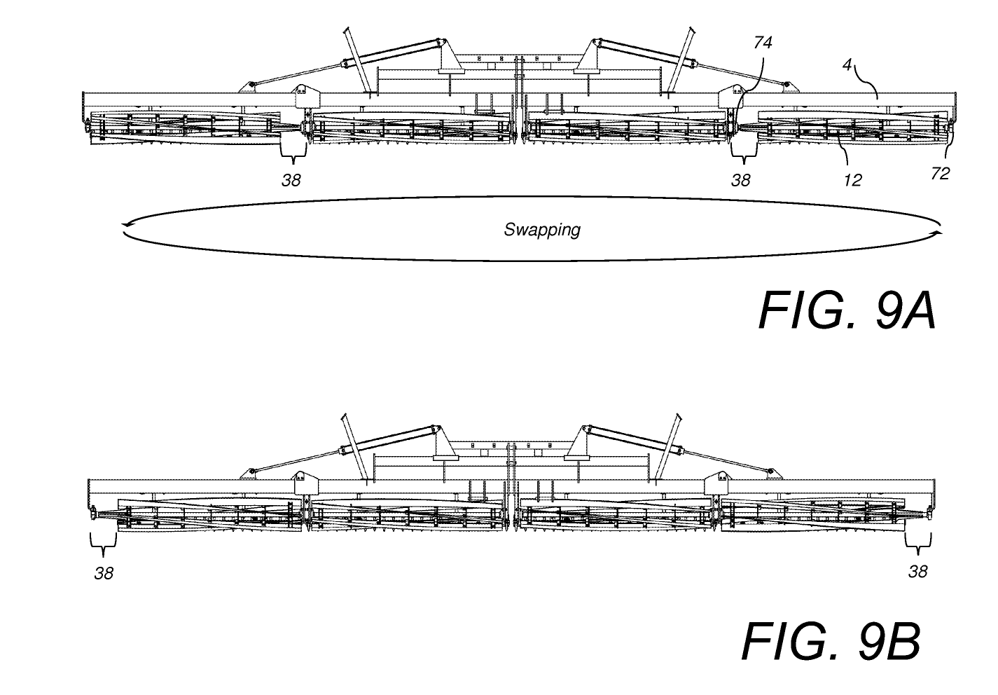

As shown in FIG. 9A and FIG. 9B, in an embodiment of the present invention, the chopper baskets 12 on the wing fixed width sections 20 of the tillage implement 2 can be adjusted by removing four bolts from each wing flange bearing 74 and two bolts from each pillow block bearing 72; removing the wing chopper baskets 12 from the tool bar 4; swapping positions of the right and left wing section 20 chopper baskets 12; reattaching the wing chopper baskets 12 to the tool bar 4 in a desired position; and reattaching the bolts to the flange bearings 74 and the pillow block bearings 72. In this embodiment, a first, outboard position of the chopper baskets 12, as shown in FIG. 9A, puts a 12-inch displacement 38 between the wing section 20 chopper baskets 12 and the corresponding center fixed width sections 22 of the tillage implement 2. A second, inboard position of the chopper baskets 12, as shown in FIG. 9B, puts a 12-inch displacement 38 on the outside of each wing section 20 chopper basket 12. This embodiment is particularly useful for chopper baskets with directional blades or other directional ground-working tools.

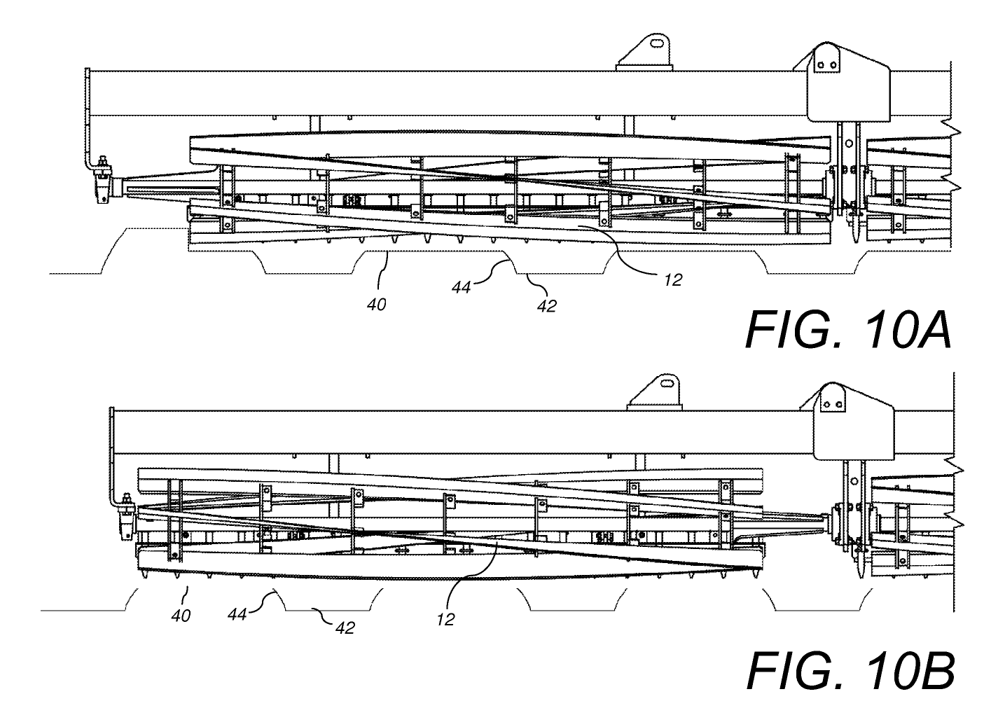

FIG. 10A and FIG. 10B show wing sections 20 of an embodiment of the tillage implement 2 above typical crop rows. Typical crop rows have alternating beds 40 and furrows 42, with transitions 44 in between. Beds 40 are raised portions of land with a minimum width of conditioned soil for planting, and furrows 42 are low portions of land used for routing water to crops. FIG. 10A illustrates a condition multiple row agricultural implement users must avoid. When using a multiple row implement, it is very important that the ends of ground-working tools 11 do not run through the surface of crop row beds 40 so that already-worked and yet-to-be-worked beds 40 are not damaged. FIG. 10A shows the end of a chopper basket 12 right over the middle of the surface of a crop row bed 40. Most multiple row agricultural implements can only be used for one or two different crop row spacing configurations without having the ends of their ground-working tools pulled through the surface of a bed 40. In proper position, the ends of ground-working tools 11 line up with transitions 44 or furrows 42 rather than beds 40. FIG. 10B shows a chopper basket 12 in proper position over crop rows with its end lining up with a transition 44. This positioning of ground-working tools does not cause damage to already-tilled or yet-to-be-tilled crop row beds 40. With the disclosed adjustability of ground-working tools, a single implement can be used to work crop rows with a variety of spacing configurations without damaging adjacent beds. In the past, multiple agricultural implements were needed to be able to work a variety of crop row spacing configurations.

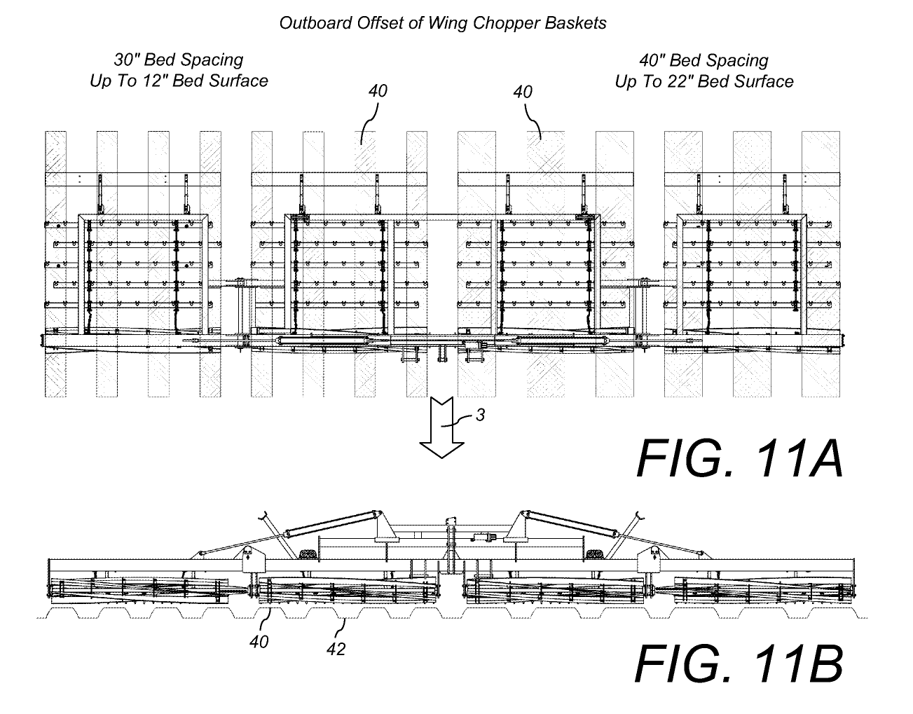

FIG. 11A shows an overhead view and FIG. 11B shows a front, elevational view of the tillage implement 2 over beds 40 and furrows 42 of crop rows with the ground-working tools 11 in a first, outboard position. The left sides of FIG. 11A and FIG. 11B show how the tillage implement 2 lines up with crop row beds 40 and furrows 42 in a 16 Row 30″ crop row spacing configuration. The right sides of FIG. 11A and FIG. 11B show how the tillage implement 2 lines up with crop row beds 40 and furrows 42 in a 12 Row 40″ crop row spacing configuration. The first, outboard position of ground-working tools 11 of the tillage implement 2, illustrated in FIG. 11A and FIG. 11B, allows for use of the tillage implement 2 for 16 Row 30″ and 12 Row 40″ crop spacing configurations because the ends of ground-working tools 11 in this outboard position are not over crop row bed 40 surfaces in those spacing configurations. In this application, “crop row spacing” is synonymous with “bed spacing,” “bed surface spacing,” “row spacing,” and “crop spacing.”

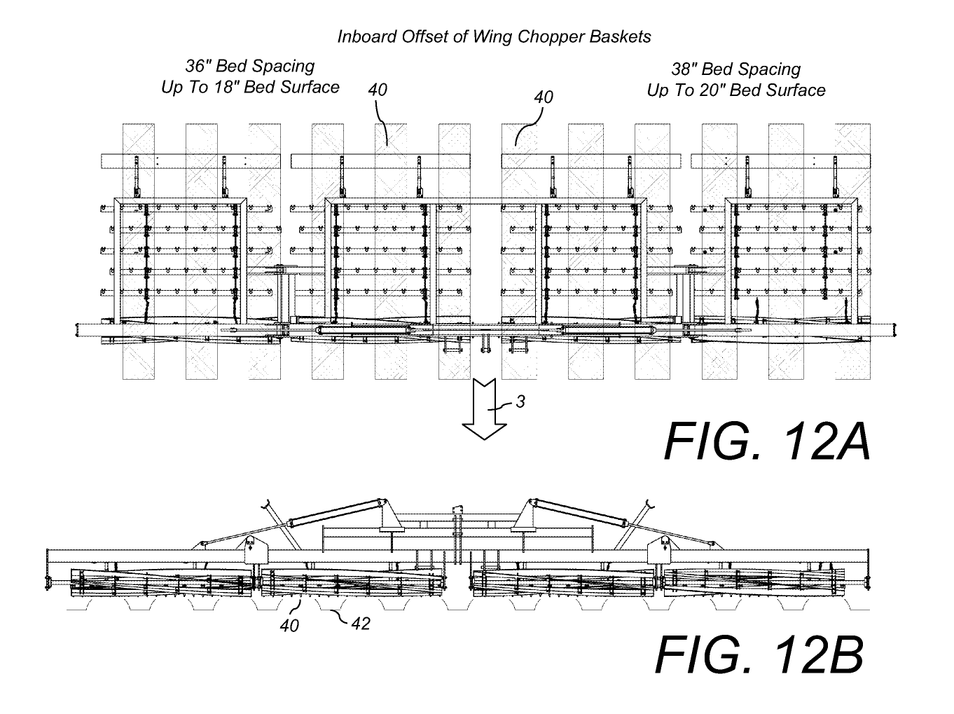

FIG. 12A shows an overhead view and FIG. 12B shows a front, elevational view of the tillage implement 2 over beds 40 and furrows 42 of crop rows with the ground-working tools 11 in a second, inboard position. The left sides of FIG. 12A and FIG. 12B show how the tillage implement 2 lines up with crop row beds 40 and furrows 42 in a 12 Row 36″ crop row spacing configuration. The right sides of FIG. 12A and FIG. 12B show how the tillage implement 2 lines up with crop row beds 40 and furrows 42 in a 12 Row 38″ crop row spacing configuration. The second, inboard position of ground-working tools 11 of the tillage implement 2, illustrated in FIG. 12A and FIG. 12B, allows for use of the tillage implement 2 for 12 Row 36″ and 12 Row 38″ crop row spacing configurations because the ends of ground-working tools 11 in this inboard position are not over crop row bed 40 surfaces in those spacing configurations.

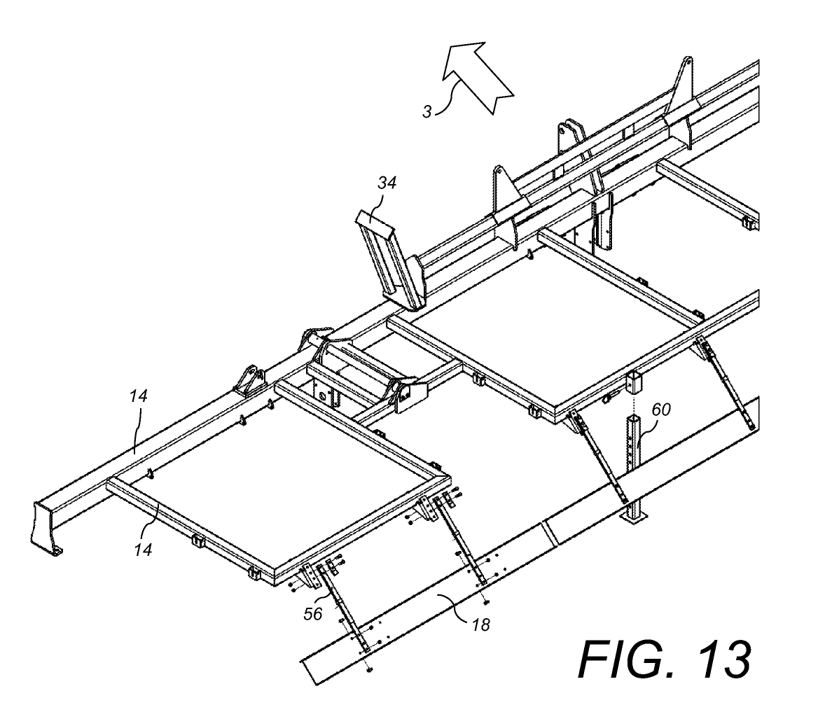

FIG. 13 is a view of the tool bar 4, metal frame 14, and drag board assemblies 18 of one side of the tillage implement 2. In this embodiment of the present invention, a metal frame 14 is welded to each fixed width section 6 of the tool bar 4, and a drag board assembly 18 connects to each metal frame 14. Attached to the outer portion of each center section 22 of the tool bar 4 is a transport position connector 34, which helps support the weight of the corresponding wing fixed width section 20 when folded up in transport position. Removable jack stand assemblies 60 attach to the metal frames 14 of the center fixed width sections 22 of the tillage implement 2 via clevis pins. The removable stand assemblies 60, or jack stands, are meant for attachment when the tillage implement 2 is not in use. The stand assemblies 60 keep weight off leaf springs 56 of the drag board assemblies 18 while the tillage implement 2 is at rest. The stand assemblies 60 must be removed prior to using the tillage implement 2 or they will be damaged during operation.

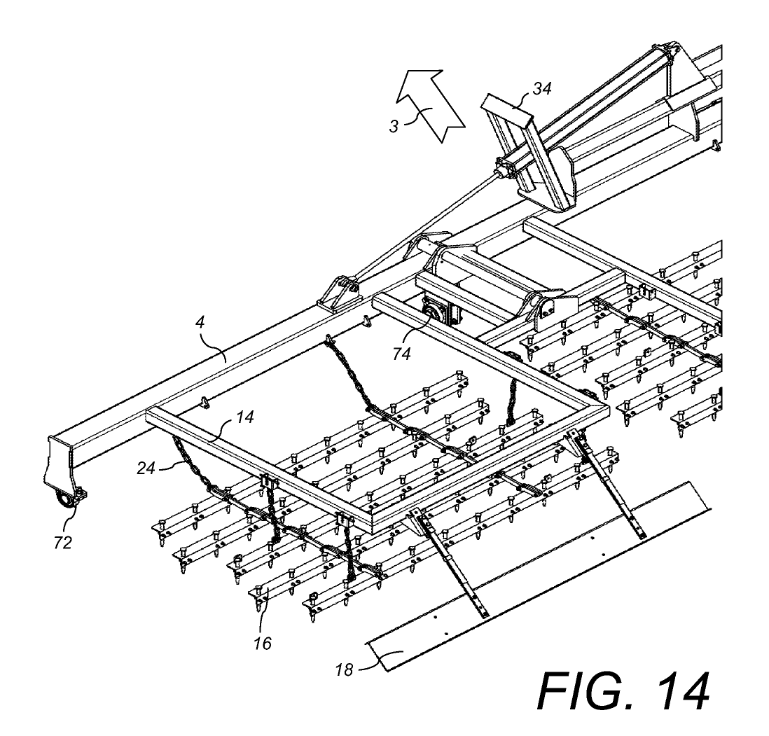

FIG. 14 is a close, perspective view of a wing section 20 of an embodiment of the present invention showing assembled drag harrow spikes 16 and a drag board assembly 18. In this embodiment, a metal frame 14 is welded to the tool bar 4 of the tillage implement 2; a chopper basket 12 (not shown) connects to the tool bar 4 with a two-bolt pillow block bearing 72 and a four-bolt flange bearing 74; five bar drag harrow spikes 16 connect to the tool bar 4 and to the metal frame 14 via chain linkages 24; and a drag board assembly 18 is bolted to the metal frame 14.

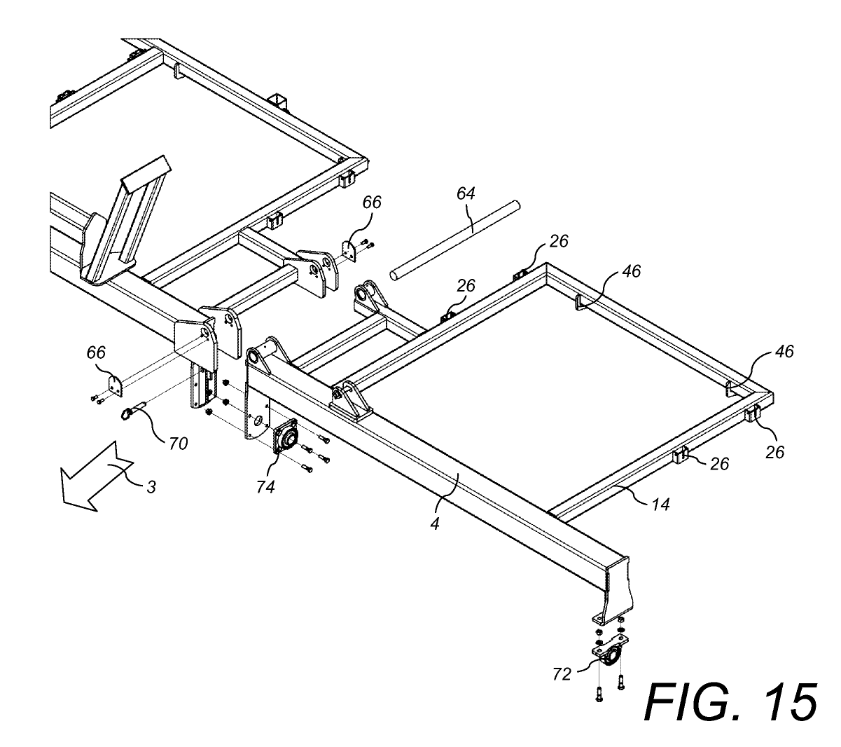

FIG. 15 shows an exploded view of an embodiment of the tool bar 4 and metal frame 14 of a wing section 20 of the tillage implement 2. This view shows drag board connectors 46; harrow chain linkage connectors 26; and a four-bolt flange bearing 74 and a two-bolt pillow block bearing 72 for connection to a chopper basket 12. A hinge pin 64, hinge caps 66, and bolts connect each wing fixed width section 20 to a corresponding center fixed width section 22, allowing the wing fixed width section 20 to be folded up to a transport position. Pins 70 lock the wing fixed width sections 20 in place in working and transport positions.

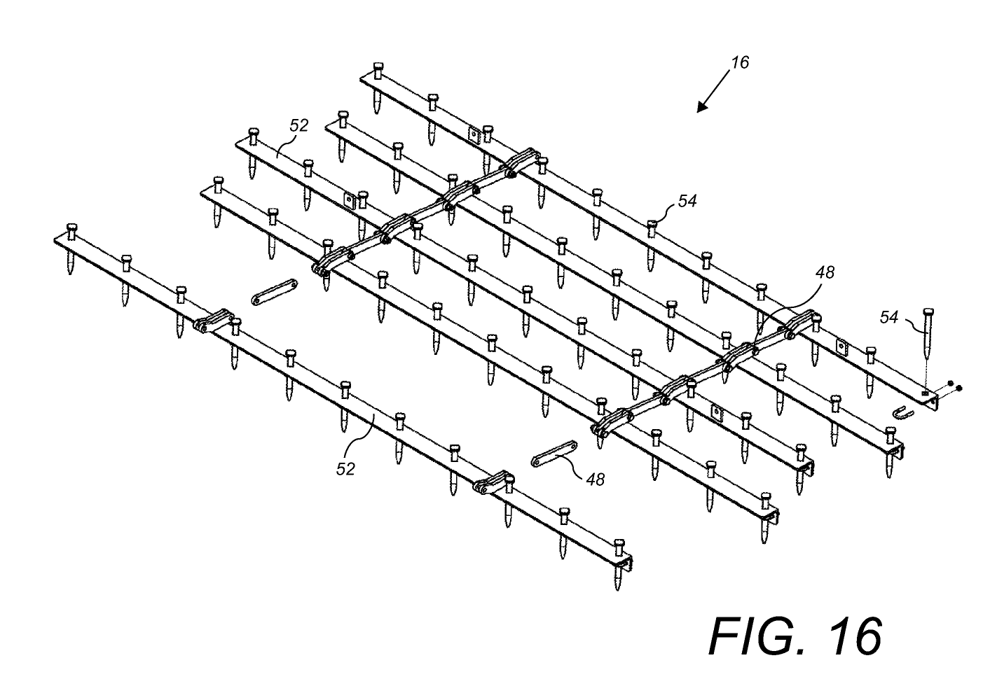

In an embodiment, shown in FIG. 16, each five bar drag harrow spike assembly 16 includes five tooth bars 52, which have openings to fit individual harrow spikes 54, and harrow connectors 48, which connect the five tooth bars 52 to each other. Drag harrow spikes are used for cutting through clumps, manure, grasses, weeds, etc. to break up material into finer pieces and spread it across the ground to help level the soil. The tooth bars 52 are staggered for better conditioning of the soil. In this application, “harrow spikes” are synonymous with “harrow teeth.” Individual harrow spikes 54 are 11 inches long and are fastened to the tooth bars 52 with U-bolts and nyloc nuts.

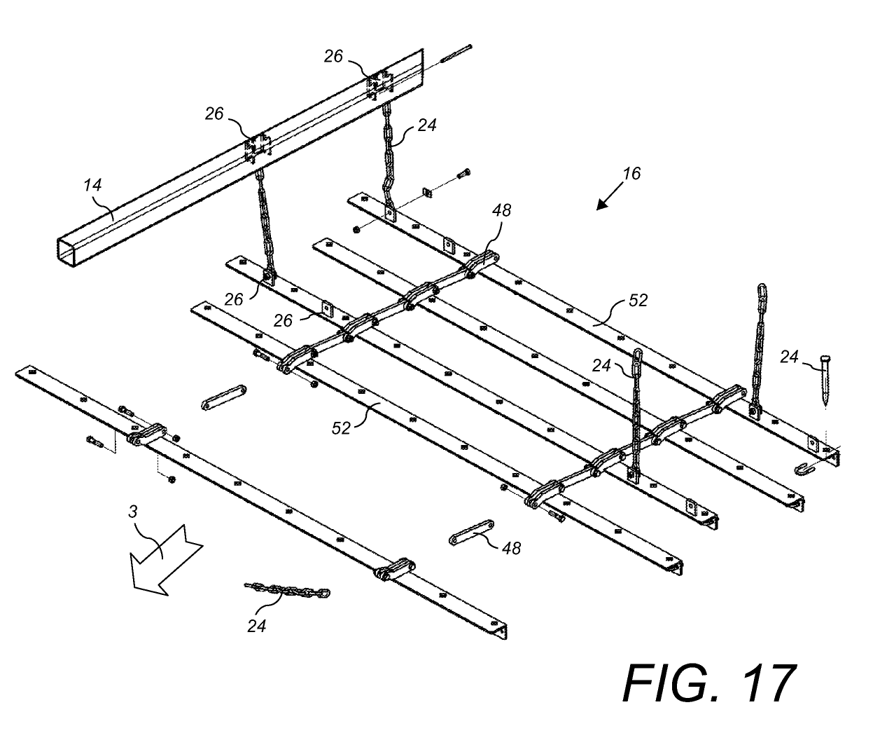

FIG. 17 shows an exploded view of an embodiment of a five bar drag harrow spike assembly 16. This embodiment has harrow connectors 48 that connect five tooth bars 52 to each other, the tooth bars 52 being staggered. These harrow connectors 48 connect the tooth bars 52 with grade 8 hex bolts and nyloc nuts. Chain linkages 24 connect to tooth bars 52 of each of the five bar drag harrow spike assemblies 16, to the metal frame 14 of the tillage implement 2, and to the tool bar 4 of the tillage implement 2 via chain linkage connectors 26. The chain linkage connectors 26 connect the chain linkages 24 to the tooth bars 52 and to the tool bar 4 with hex bolts, washers, and nyloc nuts. The chain linkage connectors 26 connect to the metal frame 14 with cotter pins. The bolts, washers, and nuts of the chain linkage connectors 26 of the wing section 20 harrow spike assemblies 16 can be removed and reattached in alternate positions to allow use for various crop row spacing configurations. These alternate positions of the wing section 20 five bar drag harrow spike assemblies 16 allow the drag harrow spikes 16 to be aligned with wing section 20 chopper baskets 12 in both the inboard and outboard position.

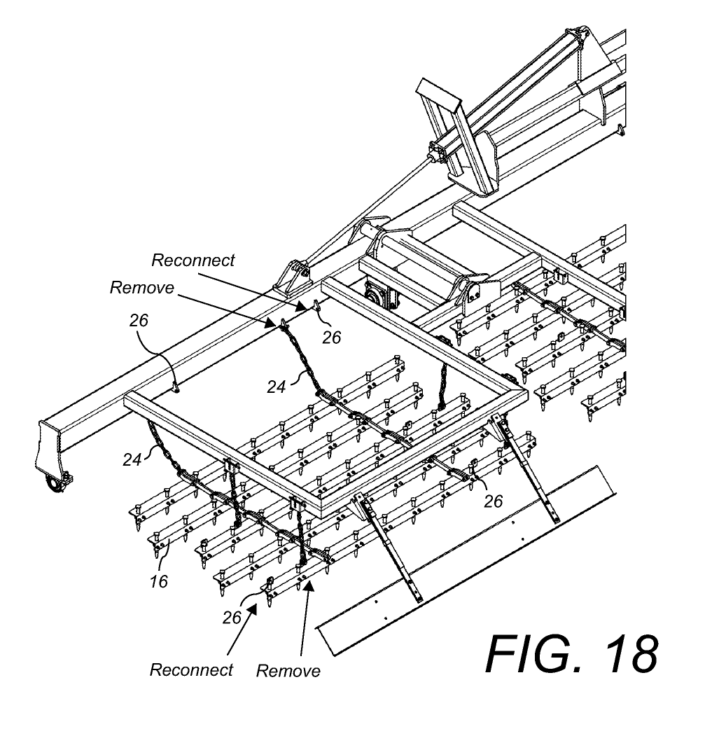

FIG. 18 illustrates the horizontal adjustability of wing section 20 five bar drag harrow spikes 16 in an embodiment of the tillage implement 2. Horizontal adjustment of the wing five bar drag harrow spikes 16 between alternate positions allows for use of the tillage implement 2 with a variety of crop row configurations. To reconfigure wing section 20 five bar drag harrow spikes 16, the bolts, washers, and nuts connecting the front two chain linkages 24 to the tool bar 4 are removed; the bolts, washers, and nuts connecting the back four chain linkages to the tooth bars 52 are removed; the chain linkages 24 are moved to alternate chain linkage connectors 26 on the tool bar 4 and on the tooth bars 52; and the bolts, washers, and nuts are reattached at the alternate chain linkage connectors 26.

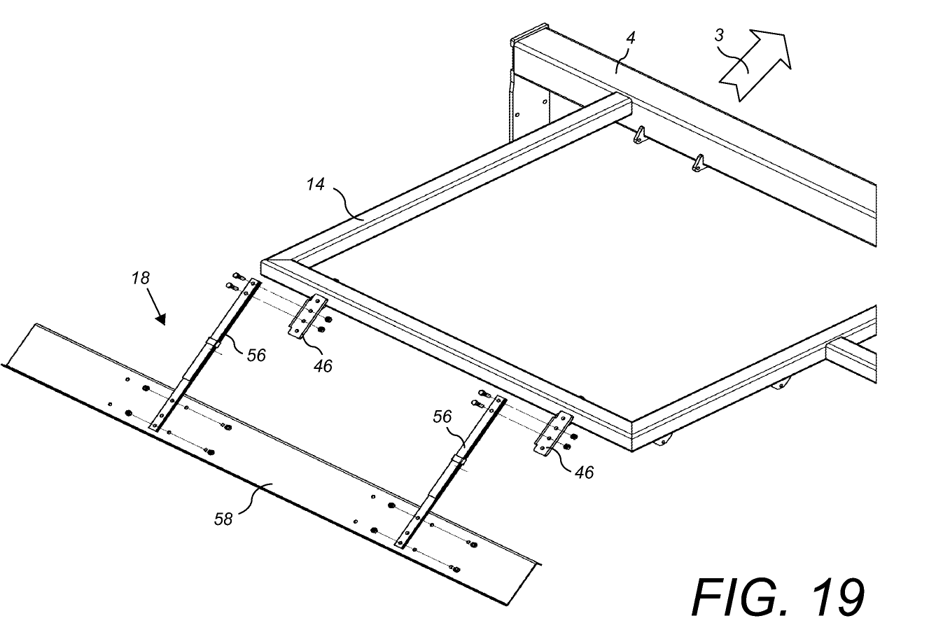

FIG. 19 shows an exploded view of an embodiment of a drag board assembly 18 having leaf spring assemblies 56 which connect to a drag board 58 via hex bolts and nyloc nuts. The leaf spring assemblies 56 connect to drag board connectors 46 on the metal frame 14 of the tillage implement 2 with hex bolts and nyloc nuts. Drag board assemblies 18 are used to level tilled soil. The leaf springs 56 provide force to push the drag boards down, smoothing out the soil. In this embodiment, the wing section 20 drag boards 58 are horizontally adjustable for use with different crop row spacing configurations. Wing section 20 drag board 58 adjustment allows the wing drag boards 58 to be aligned with the wing chopper baskets 12 and wing harrow spikes 16 in both the inboard and outboard positions.

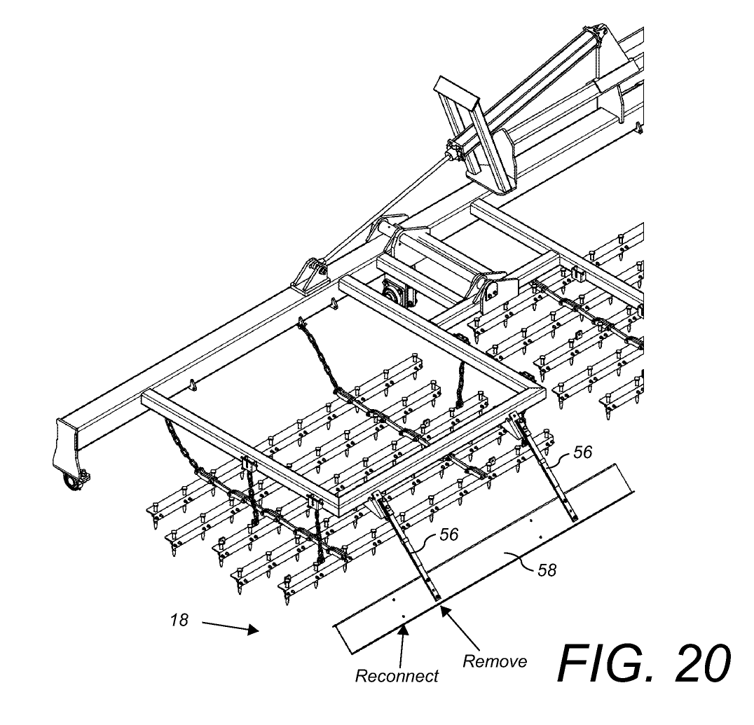

FIG. 20 illustrates the horizontal adjustability of wing section 20 drag board assemblies 18 in an embodiment of the tillage implement 2. This adjustment is conducted by removing the nuts and bolts connecting the leaf spring assemblies 56 to the wing drag boards 58; lining up the leaf spring assemblies 56 with alternative bolt positions on the wing drag boards 58; and reattaching the nuts and bolts in the alternative bolt positions on the wing drag boards 58. The alternate positioning of wing section 20 drag board assemblies 18 allows use of the tillage implement 2 for a variety of crop row configurations.

An embodiment of the tillage implement 2 utilizes wing-mounted high-clearance gauge wheel assemblies. These gauge wheel assemblies are removable and capable of attachment anywhere along the tool bar 4 of the tillage implement 2. Each gauge wheel assembly consists of a wheel and tire; a high-clearance bracket; a turnbuckle; a universal shank; a spindle; a hub; a hub cap; cone bearings; seals; nuts; and bolts. The wheel assemblies provide traction for transportation when the implement 2 is not tilling crop rows. Gauge wheel assemblies must be positioned over a furrow 42 in the particular crop row spacing configuration being worked so that crop row beds 40 are not damaged by the wheels when the tillage implement 2 is in operation.

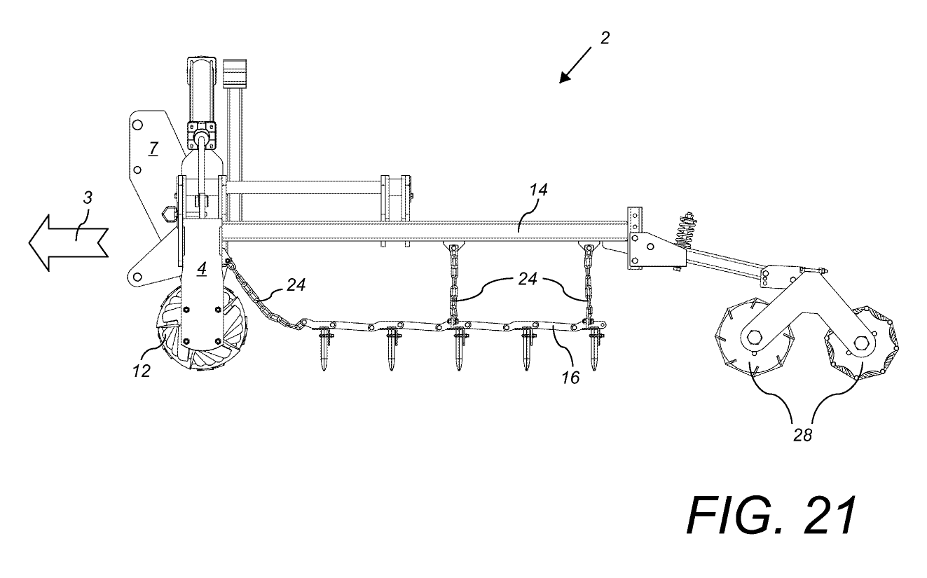

In another embodiment of the present invention, shown in FIG. 21, a tillage implement 2 includes two rollers 28 mounted to each of its fixed width sections 6 rather than drag board assemblies. This embodiment of a tillage implement 2 includes a metal frame 14 connected to each fixed width section 6 of a tool bar 4, and two rollers 28 connect to the back of each metal frame 14. The ground-working tools 11 of this embodiment also include five bar drag harrow spikes 16, which connect to the metal frame 14 and to the tool bar 4 via chain linkages 24, and chopper baskets 12, which connect to the tool bar 4 with pillow block and flange bearings. Rollers 28, like drag board assemblies, are used to further level tilled soil.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. An adjustable multiple row agricultural implement comprising:
a tool bar configured for connection to a vehicle;
said tool bar comprising two or more fixed width sections;
ground-working tools mounted to each of said fixed width sections; and
said ground-working tools being horizontally adjustable to alternate positions allowing use with a range of crop row spacing configurations.

2. The adjustable multiple row agricultural implement according to claim 1, wherein said adjustable multiple row agricultural implement is a multiple row tillage implement.

3. The adjustable multiple row agricultural implement according to claim 2, wherein said ground-working tools comprises chopper baskets, drag harrow spikes, and drag boards.

4. The adjustable multiple row agricultural implement according to claim 2, wherein said ground-working tools comprises chopper baskets, drag harrow spikes, and rollers.

5. The adjustable multiple row agricultural implement according to claim 1, wherein said ground-working tools are configured for horizontal adjustment to alternate positions by sliding said ground-working tools along a horizontal shaft to alternate positions on said implement.

6. The adjustable multiple row agricultural implement according to claim 1, wherein said ground-working tools are configured for horizontal adjustment to alternate positions by removal of said ground-working tools from said implement, 180-degree reversal of said ground-working tools, and reattachment of said ground-working tools to said implement.

7. The adjustable multiple row agricultural implement according to claim 1, wherein said ground-working tools are configured for horizontal adjustment to alternate positions by removal of said ground-working tools from said implement, swapping positions of said ground-working tools, and reattachment of said ground-working tools to said implement.

8. The adjustable multiple row agricultural implement according to claim 1, wherein said ground-working tools are configured for horizontal adjustment to alternate positions by removal of said ground-working tools from said implement and reattachment of said ground-working tools to said implement in alternate positions on said implement.

9. The adjustable multiple row agricultural implement according to claim 1, wherein each said fixed width section includes:
a first configuration with said ground-working tools mounted in a first predetermined transverse spacing;
a second configuration with said ground-working tools mounted in a second predetermined transverse spacing;
wherein said implement in said first configuration is configured for working a first set of crop row spacing configurations; and
wherein said implement in said second configuration is configured for working a second set of crop row spacing configurations.

10. The adjustable multiple row agricultural implement according to claim 1, wherein said two or more fixed width sections include wing fixed width sections.

11. The adjustable multiple row agricultural implement according to claim 10, wherein said fixed width sections includes a center section located between said wing sections.

12. The adjustable multiple row agricultural implement according to claim 10, wherein said fixed width sections includes two center sections positioned in adjacent, transverse relation to each other between said wing sections.

13. The adjustable multiple row agricultural implement according to claim 12, wherein said wing sections comprises four wing sections configured in pairs of inboard and outboard wing sections on each side of said implement.

14. The adjustable multiple row agricultural implement according to claim 10, wherein said wing sections are capable of folding up to a transport position.

15. An adjustable multiple row tillage implement comprising:
a tool bar configured for connection to a vehicle;
said tool bar comprising wing fixed width sections and one or more center fixed width sections;
ground-working tools mounted to each of said fixed width sections;
said ground-working tools being horizontally adjustable to alternate positions allowing use with a range of crop row spacing configurations;
wherein said ground-working tools comprises chopper baskets, drag harrow spikes, and drag boards;
wherein each fixed width section includes a first configuration with said ground-working tools in a first predetermined transverse spacing;
wherein each fixed width section includes a second configuration with said ground-working tools in a second predetermined transverse spacing;
wherein said implement in said first configuration is configured for working a first set of crop row spacing configurations; and
wherein said implement in said second configuration is configured for working a second set of crop row spacing configurations.

16. The adjustable multiple row tillage implement according to claim 15, wherein said ground-working tools are configured for horizontal adjustment to alternate positions by sliding said ground-working tools along a horizontal shaft to alternate positions on said implement.

17. The adjustable multiple row tillage implement according to claim 15, wherein said ground-working tools are configured for horizontal adjustment to alternate positions by removal of said ground-working tools from said implement, 180-degree reversal of said ground-working tools, and reattachment of said ground-working tools to said implement.

18. The adjustable multiple row tillage implement according to claim 15, wherein said ground-working tools are configured for horizontal adjustment to alternate positions by removal of said ground-working tools from said implement, swapping positions of said ground-working tools, and reattachment of said ground-working tools to said implement.

19. The adjustable multiple row tillage implement according to claim 15, wherein said ground-working tools are configured for horizontal adjustment to alternate positions by removal of said ground-working tools from said implement and reattachment of said ground-working tools to said implement in alternate positions on said implement.

20. A method of adjusting ground-working tools of an adjustable multiple row agricultural implement, the implement having a tool bar with two or more fixed width sections and ground-working tools being mounted to each of said fixed width sections, the method comprising:
unfastening ground-working tools from said implement;
sliding said ground-working tools along a horizontal shaft to an alternate position on said implement; and
fastening said ground-working tools to said implement in said alternate position on said implement.
